(19) United States
(12) Patent Application Publication
(10) Pub. No.: US 2025/0153262 A1
(43) Pub. Date: May 15, 2025

(54) Welding Apparatus and Welding Method

(71) Applicant: LG Energy Solution, Ltd., Seoul (KR)

(72) Inventor: Young Seok Baek, Daejeon (KR)

(73) Assignee: LG Energy Solution Ltd., Seoul (KR)

(21) Appl. No.: 18/833,130

(22) PCT Filed: Feb. 15, 2023
(86) PCT No.: PCT/KR2023/002213

§ 371 Date: Jul. 25, 2024

(30) Foreign Application Priority Data
Feb. 15, 2022 (KR) 10-2022-0019798

(51) Int. Cl. B23K 20/10

(52) U.S. Cl. CPC B23K 20/10

(57) ABSTRACT

A welding apparatus includes: a horn having a first welding surface on which a plurality of first protrusions are provided; and an anvil facing the horn with a plurality of electrode tabs, which are included in a secondary battery, therebetween, and having a second welding surface on which a plurality of second protrusions are provided. Each of the first protrusions has a planar cross-section that may have a shape different from a shape of a planar cross-section of each of the second protrusions, and each of the electrode tabs arranged between the horn and the anvil may have a width greater than a width of the horn. A method including the same is also provided.

### CROSS-REFERENCE TO RELATED APPLICATION

The present application is a national phase entry under 35 U.S.C § 371 of International Application No. PCT/KR2023/002213 filed on Feb. 15, 2023 which claims the benefit of priority based on Korean Patent Application No. 10-2022-0019798, filed on Feb. 15, 2022, all contents of which are incorporated herein by reference.

### TECHNICAL FIELD

The present disclosure relates to a welding apparatus and a welding method, and more particularly, to a welding apparatus and welding method capable of minimizing an occurrence of a welding defect.

### BACKGROUND ART

A demand for secondary batteries as energy sources for electronic devices such as mobile phones, notebook computers, and wearable devices, or electric vehicles, etc., increases. According to the type of an electrode, the secondary batteries are classified into nickel-cadmium secondary batteries, nickel-hydrogen secondary batteries, lithium secondary batteries, and so on, and research on and development for the lithium secondary batteries, which have advantages such as a high operating voltage and a high energy density per unit weight, are actively carried out.

In general, the secondary batteries may include an electrode assembly and a case in which the electrode assembly is used. A plurality of electrodes may be stacked in one electrode assembly, and in order to easily supply electricity generated from the plurality of electrodes to the outside, an electrode tab may be provided on each of the electrodes. The plurality of electrode tabs may be welded to each other through a welding process using a welding apparatus including a horn and an anvil. However, welding strength may be not properly secured during the welding process, or a welding defect may occur due to a deviation and the like occurring during a manufacturing process.

### DISCLOSURE OF THE INVENTION

### Technical Problem

An embodiment according to the present invention is to provide a welding apparatus and welding method capable of minimizing an occurrence of a welding defect.

The technical problems of the present invention are not limited to the foregoing technical problems, but other technical problems not described herein will be clearly understood by those skilled in the art from descriptions below.

### Technical Solution

A welding apparatus according to an embodiment of the present invention may include: a horn having a first welding surface on which a plurality of first protrusions are provided; and an anvil facing the horn with a plurality of electrode tabs, which are provided in a secondary battery, therebetween, and having a second welding surface on which a plurality of second protrusions are provided, wherein each of the first protrusions has a planar cross-section having a shape different from a shape of a planar cross-section of each of the second protrusions, and each of the electrode tabs aligned between the horn and the anvil has a width greater than a width of the horn.

According to an embodiment, the electrode tab may include a start point, which is disposed to be relatively far from an electrode lead provided in the secondary battery, and an end point which is disposed to be adjacent to the electrode lead. The first welding surface may include a first area close to the start point of the electrode tab, and a second area far from the start point of the electrode tab. Each of the plurality of first protrusions may be disposed to be spaced apart from the first protrusion adjacent thereto on the first area, and may be disposed without spacing from the first protrusion adjacent thereto on the second area.

According to an embodiment, in the first area, a spaced distance between the plurality of first protrusions may be provided to be the same as a pitch of the first protrusion.

According to an embodiment, at least one of the first protrusion or the second protrusion may have a pitch of 1.2 mm to 1.5 mm.

According to an embodiment, the width of the horn may be provided to be smaller than the width of the electrode tab by 2 mm to 2.5 mm.

According to an embodiment, the anvil may have a width that is greater than or equal to the width of the horn.

According to an embodiment, each of the first protrusion and the second protrusion may have a shape of a frustum of quadrangular pyramid. The first protrusion may include a first outer surface facing the anvil, wherein the first outer surface has a rectangle shape having a horizontal length extending in a first direction and a vertical length extending in a second direction. The second protrusion may include a second outer surface facing the horn, wherein the second outer surface has a rhombus shape in which a first diagonal parallel to the first direction and a second diagonal parallel to the second direction are perpendicular to each other.

According to an embodiment, the horn may include a first side surface, a second side surface, a third side surface, and a fourth side surface, each of which is in contact with the first welding surface to define an edge. One side surface of the first side surface, the second side surface, the third side surface, and the fourth side surface may have a curvature radius greater than each of remaining side surfaces of the first side surface, the second side surface, the third side surface, and the fourth side surface.

According to an embodiment, the first side surface may be disposed to be close to the start point of the electrode tab, and the first side surface may have a curvature radius greater than at least one of the second side surface, the third side surface, or the fourth side surface.

A welding method according to an embodiment of the present invention may include: aligning a horn, which has a first welding surface on which a plurality of first protrusions are provided, and an anvil, which has a second welding surface on which a plurality of second protrusions are provided, to face each other with a plurality of electrode tabs, which are included in a secondary battery, therebetween; and pressing the plurality of electrode tabs using the horn, wherein each of the first protrusions has a planar cross-section having a shape different from a shape of a planar cross-section of each of the second protrusions, and each of the electrode tabs aligned between the horn and the anvil has a width greater than a width of the horn.

### Advantageous Effects

According to the embodiment of the present invention, the welding strength may be secured during the ultrasonic welding of the electrode tabs.

Moreover, according to the embodiment of the present invention, the damage to the electrode tabs due to the direct contact of the horn may be minimized and thus, the occurrence of the welding defect (e.g., disconnection) may be prevented or minimized.

Furthermore, according to the embodiment of the present invention, the manufacturing process defect may be prevented or minimized and thus, the performance of the secondary battery may be secured and the safety of the secondary battery may be improved.

In addition, the various effects directly or indirectly found through this document may be provided.

### BRIEF DESCRIPTION OF THE DRAWINGS

FIG. 1 is an exploded perspective view illustrating a secondary battery according to an embodiment of the present invention.

FIG. 2 is a view illustrating an apparatus for manufacturing a secondary battery according to an embodiment of the present invention.

FIG. 3 is a plan view illustrating a horn included in an apparatus for manufacturing a secondary battery according to an embodiment of the present invention.

FIG. 4 is a cross-sectional view illustrating the horn taken along a line “A-A′” in FIG. 3.

FIG. 5 is a view illustrating tensile strength according to an interval between first protrusions of a horn included in an apparatus for manufacturing a secondary battery according to an embodiment of the present invention.

FIG. 6 is a plan view illustrating an anvil included in an apparatus for manufacturing a secondary battery according to an embodiment of the present invention.

FIG. 7 is a cross-sectional view illustrating the anvil taken along a line “B-B′” in FIG. 6.

FIGS. 8a and 8b are views for explaining a width relationship between a horn and an anvil during a process of manufacturing a secondary battery according to an embodiment of the present invention.

FIG. 9a is a view for explaining an arrangement relationship between a horn and an electrode tab during a process of manufacturing a secondary battery according to an embodiment of the present invention, FIG. 9b is a view illustrating an electrode tab after a manufacturing process according to an embodiment of the present invention, and FIG. 9c is a view illustrating an electrode tab after a manufacturing process according to comparative example.

FIG. 10 is a view illustrating a relationship between the number of stacked electrode tabs of a secondary battery and a first width of a first welding surface according to an embodiment of the present invention.

FIG. 11 is a plan view illustrating a horn having a side surface having a curved surface shape according to another embodiment of the present invention.

FIG. 12 is a cross-sectional view taken along a line “C-C′” in FIG. 11.

FIG. 13 is a plan view illustrating an anvil having a side surface having a curved surface shape according to another embodiment of the present invention.

FIG. 14 is a cross-sectional view taken along a line “D-D′” in FIG. 13.

### DETAILED DESCRIPTION

Hereinafter, preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

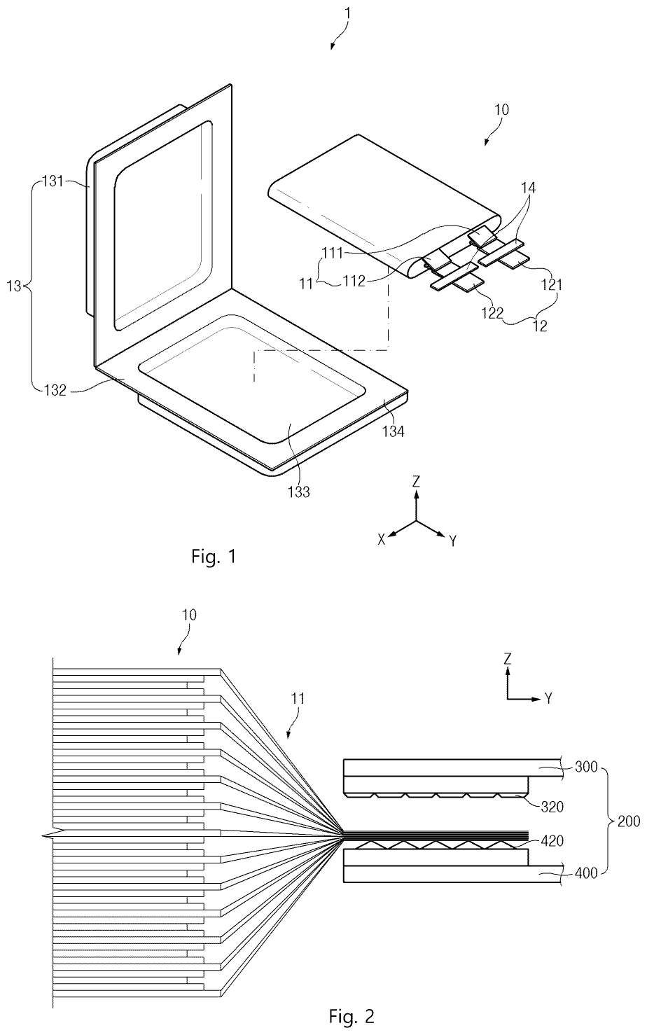

FIG. 1 is an exploded perspective view illustrating a secondary battery according to an embodiment of the present invention.

Referring to FIG. 1, a secondary battery 1 according to an embodiment of the present invention may include an electrode assembly 10 and a case 13 surrounding the electrode assembly 10.

The electrode assembly 10 is a power generation device, in which a positive electrode and a negative electrode are sequentially stacked in a state in which a separator is interposed therebetween, and may have a stacked type or stack and folding type structure. The separator included in the electrode assembly 10 may insulate the positive electrode and the negative electrode from each other.

The electrode assembly 10 may include a plurality of electrode tabs 11 extending from the electrode assembly 10. The electrode assembly 10 may include a positive electrode tab 111 and a negative electrode tab 112. The positive electrode tab 111 may extend from the positive electrode of the electrode assembly 10 to protrude to the outside of the electrode assembly 10. The negative electrode tab 112 may extend from the negative electrode of the electrode assembly 10 to protrude to the outside of the electrode assembly 10.

An electrode lead 12 may be connected to the electrode tab 11. For example, the electrode lead 12 may be connected to the electrode tab 11 through a welding process such as laser welding. The electrode lead 12 may include a positive electrode lead 121 and a negative electrode lead 122. The positive electrode lead 121 and the negative electrode lead 122 may extend in the same direction or in opposite directions according to a formed position of each of the positive electrode tab 111 and the negative electrode tab 112. The positive electrode lead 121 and the negative electrode lead 122 may have different materials. For example, the positive electrode lead 121 may have the same aluminum (Al) material as that of the positive electrode, and the negative electrode lead 122 have the same copper (Cu) material as that of the negative electrode, or a copper material coated with nickel (Ni). A portion of the electrode lead 12, which protrudes to the outside of the case 13, may serve as a terminal portion to be electrically connected to an external terminal.

The electrode lead 12 may have a portion that is surrounded by an insulation part 14. The insulation part 14 may be disposed on a sealing part 134, on which an upper pouch 131 and a lower pouch 132 of the case 13 are thermally fused to each other, to bond the electrode lead 12 to the case 13. In addition, electricity generated from the electrode assembly 10 may be prevented from flowing to the case 13 through the electrode lead 12, and sealing of the case 13 may be maintained. The insulation part 14 is made of a nonconductor having non-conductivity, through which electricity does not flow well. A material, which is easily attached to the electrode lead 12 and has a relatively small thickness, may be used in the insulation part 14. For example, the insulation part 14 may be made of an insulation tape. The material of the insulation part 14 is not limited to the insulation tape, and various members may be used as long as the members are capable of insulating the electrode lead 12.

The case 13 provides an accommodation space capable of accommodating the electrode assembly 10, and has a pouch shape as a whole. The case 13 may accommodate and seal the electrode assembly 10 so that a portion of the electrode lead 12, i.e., the terminal portion, is exposed. The case 13 includes the upper pouch 131 and the lower pouch 132. The lower pouch 132 is provided with an accommodation space 133 capable of accommodating the electrode assembly 10, and the upper pouch 131 covers the accommodation space 133 at an upper side so that the electrode assembly 10 is not separated to the outside of the case 13. Here, the accommodation space 133 may be defined also in the upper pouch 131 to accommodate the electrode assembly 10 from the upper side. The upper pouch 131 and the lower pouch 132 may be manufactured so that respective sides of the upper pouch 131 and the lower pouch 132 are connected to each other, but an embodiment of the present invention is not limited thereto. For example, the upper pouch 131 and the lower pouch 132 may be manufactured in various manner such as being divided to be separately manufactured.

The electrode tabs 11 included in such a secondary battery may be connected to each other through at least one welding process of resistance welding, laser welding, and ultrasonic welding.

FIG. 2 is a view illustrating an apparatus for manufacturing a secondary battery according to an embodiment of the present invention. The manufacturing apparatus illustrated in FIG. 2 may be an ultrasonic welding apparatus that welds electrode tabs 11 to each other.

Referring to FIG. 2, an apparatus 200 for manufacturing a secondary battery according to an embodiment of the present invention may include a horn 300 and an anvil 400. The horn 300 may include a plurality of first protrusions 320, and the anvil 400 may include a plurality of second protrusions 420.

A plurality of electrode tabs 11 that are objects to be welded may be seated on the anvil 400. The horn 300 and the anvil 400 may be aligned to face each other with the plurality of electrode tabs 11 therebetween. The horn 300 may weld the plurality of electrode tabs 11 to each other by pressing the plurality of electrode tabs 11 with a fixed load and applying ultrasonic waves to the horn 300 at the same time.

While the horn 300 applies pressure vertically (e.g., in a negative (−) Z direction), the horn 300 may undergo the vibration horizontally (e.g., in an X direction and/or in an Y direction) so that frictional heat is generated on a contact surface between the electrode tabs 11. The electrode tabs 11 may be welded to each other by the generated frictional heat. As an example, the anvil 400 may be fixed while the horn 300 performs a vertical motion to press the pressure vertically.

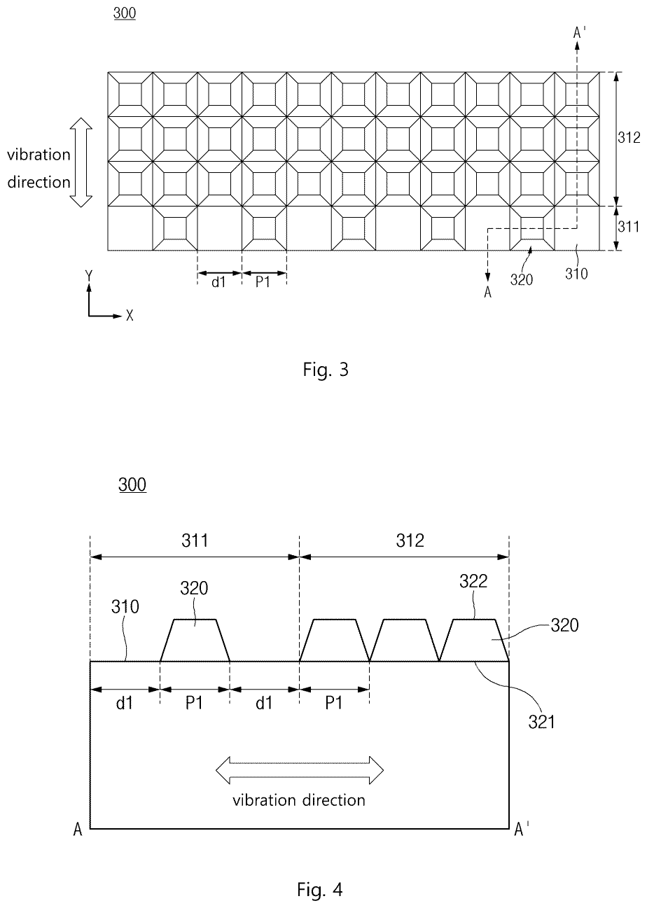

FIG. 3 is a plan view illustrating a horn included in an apparatus for manufacturing a secondary battery according to an embodiment of the present invention. FIG. 4 is a cross-sectional view illustrating the horn taken along a line “A-A′” in FIG. 3.

Referring to FIGS. 3 and 4, a horn 30 according to an embodiment of the present invention may include a plurality of first protrusions 320 provided on a first welding surface 310.

The first welding surface 310 may include a first area 311 and a second area 312. The first area may have a smaller area than the second area 312. The first area 311 may be a peripheral area adjacent to a start point of an electrode tab (e.g., the electrode tab 11 in FIG. 1) during the welding process. The start point of the electrode tab may be an area disposed to be relatively far from an electrode lead (e.g., the electrode lead 12 in FIG. 1), and an end point of the electrode tab may be an area disposed to be adjacent to the electrode lead.

The plurality of first protrusions 320 may be provided in some areas of the first area 311, and the plurality of first protrusions 320 may not be provided in remaining areas of the first area 311.

The plurality of first protrusions 320 may have the same size or different sizes between the first area 311 and the second area 312. For example, the first protrusions 320 provided in the first area 311 and the first protrusions 320 provided in the second area 312 may have the same pitch P1.

The plurality of first protrusions 320 may be arranged in a line in the first area 311 in a first direction (e.g., an X direction). In the first area 311, each of the plurality of first protrusions 320 may be disposed to be spaced a preset first spaced distance d1 from the first protrusions 320 adjacent thereto in the first direction. Each of the plurality of first protrusions 320 disposed in the first area 311 may not be spaced apart from the first protrusion 320 adjacent thereto in a second direction (e.g., an Y direction), but be disposed to be in contact with the first protrusion 320.

According to an embodiment, in the first area 311, the plurality of first protrusions 320 may be spaced by the first spaced distance d1, which is the same as or similar to the pitch of the first protrusion 320, from the adjacent first protrusion 320. The pitch P1 of each of the plurality of first protrusions 320 may be 1.2 mm to 1.5 mm. For example, when the pitch P1 of each of the plurality of first protrusions 320 is 1.2 mm, each of the plurality of first protrusions 320 may be disposed to be spaced by the first spaced distance d1 of 1.2 mm from the first protrusion 320 adjacent thereto in the first direction on the first area 311 of the first welding surface 310.

The plurality of first protrusions 320 may be arranged to have a matrix shape on the second area 312 of the first welding surface 310 in the first direction and the second direction. In the second area 312, each of the plurality of first protrusions 320 may not be spaced apart from the first protrusion 320 adjacent thereto in each of the first direction and the second direction, but are disposed to be in contact with the first protrusion 320.

Each of the plurality of first protrusions 320 may include a first inner surface 321 and a first outer surface 322 that are parallel to each other. The first inner surface 321 may be in contact with the first welding surface 310. The first outer surface 322 may be provided to oppose the first inner surface 321 and face the anvil 400 during the welding process. Each of the plurality of first protrusions 320 may have a size that gradually decreases from the first inner surface 321 to the first outer surface 322. The first outer surface 322 may have an area smaller than an area of the first inner surface 321. The area of the first outer surface 322 may be provided as an area in which the first outer surface 322 contacts the electrode tab to secure the minimum welding force and also minimize damage to the electrode tab.

Each of the plurality of first protrusions 320 may have a planar cross-section having a polygonal shape. As an example, each of the first outer surface 322 and the first inner surface 321 may have a rectangle shape having a horizontal length parallel to the first direction and vertical length parallel to the second direction (or a vibration direction). Each of the plurality of first protrusions 320 may have a shape of a frustum of a quadrangular pyramid. For example, the first outer surface 322 of each of the plurality of first protrusions 320 may be provided in a square shape having two sides parallel to the vibration direction. An embodiment including the plurality of first protrusions 320, each of which has the first outer surface 322 having a square shape, may have lower maximum plastic strain and higher tensile strength compared to Comparative Example which includes a first protrusion which has a first outer surface having a rhombus shape. Thus, an embodiment according to the present invention may prevent disconnection of the electrode tab during the welding process.

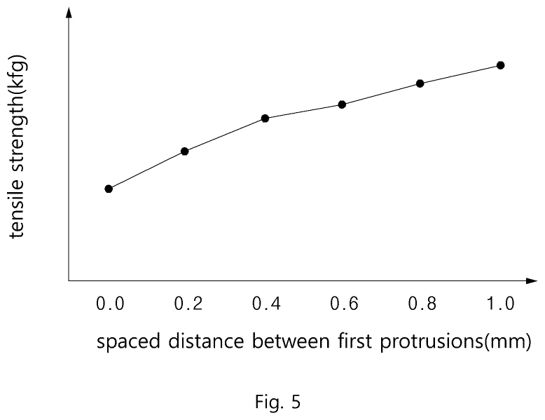

FIG. 5 is a view illustrating tensile strength according to an interval between first protrusions of a horn included in an apparatus for manufacturing a secondary battery according to an embodiment of the present invention.

Referring to FIG. 5, as a first spaced distance d1 between first protrusions (e.g., the first protrusions 320 in FIGS. 3 and 4) disposed in a first area (e.g., the first area 311 in FIGS. 3 and 4) increases, a stress propagation distance (or a non-welding area) between adjacent welding parts may increase. Accordingly, a fracture elongation may increase and tensile strength may increase. As the tensile strength of the outermost electrode tabs (e.g., the electrode tab 11 in FIG. 1) increases, the disconnection of the electrode tabs may be prevented. For example, when the distance between the first protrusions is 1.0 mm, the tensile strength may be increased by 15% compared to when the distance is 0 mm.

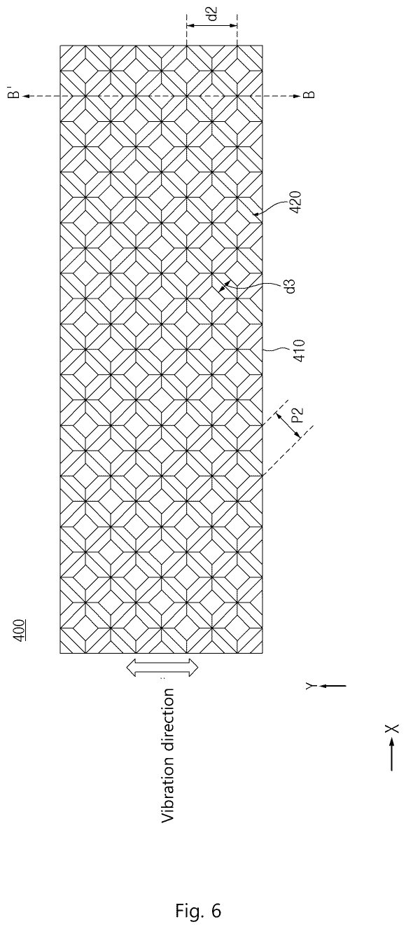

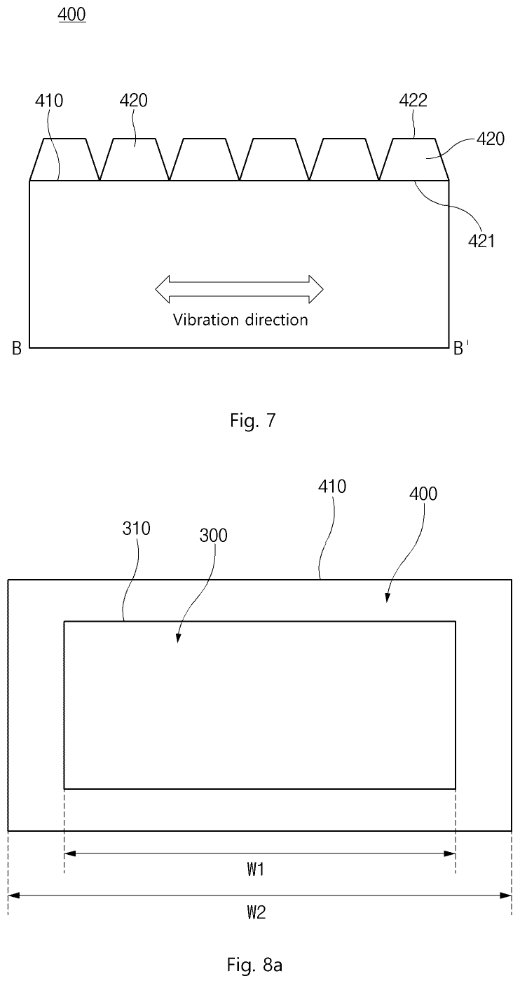

FIG. 6 is a plan view illustrating an anvil included in an apparatus for manufacturing a secondary battery according to an embodiment of the present invention. FIG. 7 is a cross-sectional view illustrating the anvil taken along a line “B-B′” in FIG. 6.

Referring to FIGS. 6 and 7, an anvil 400 according to an embodiment of the present invention may include a plurality of second protrusions 420 provided on a second welding surface 410.

The plurality of second protrusions 420 may be arranged to have a matrix shape on the second welding surface 410 in a first direction (e.g., an X direction) and a second direction (e.g., an Y direction). The plurality of second protrusions 420 may have the same size or different sizes. Each of the plurality of second protrusions 420 may be provided to have a pitch P2 of 1.2 mm to 1.5 mm.

Each of the plurality of second protrusions 420 may include a second inner surface 421 and a second outer surface 422 that are parallel to each other. The second inner surface 421 may be in contact with the second welding surface 410. The second outer surface 422 may be provided to oppose the second inner surface 421 and face a horn (e.g., the horn 300 in FIG. 2) during the welding process. Each of the plurality of second protrusions 420 may have a size that gradually decreases from the second inner surface 421 to the second outer surface 422. The second outer surface 422 may have an area smaller than an area of the second inner surface 421. The area of the second outer surface 422 may be provided as an area in which the second outer surface 422 contacts an electrode tab (e.g., the electrode tab 11 in FIG. 2) to secure the minimum welding force and also minimize damage to the electrode tab.

Each of the plurality of second protrusions 420 may have a planar cross-section having a shape different from a shape of a planar cross-section of each of a plurality of first protrusions (e.g., the first protrusion 320 in FIGS. 3 and 4). As an example, the planar cross-section of each of the plurality of second protrusions 420 may have a rhombus shape. At least one of the second outer surface 422 or the second inner surface 421 may have a rhombus shape in which a first diagonal parallel to the first direction and a second diagonal parallel to the second direction are perpendicular to each other. Each of the plurality of first protrusions 320 may have a frustum of a rectangular pyramid having the second outer surface and the second inner surface, each of which has a rhombus shape. The second diagonal included in each of the second outer surface 422 and the second inner surface 421 may be parallel to a vibration direction of the horn.

The second inner surface 421 of each of the plurality of second protrusions 420 may not be spaced a distance from the second inner surface 421 adjacent thereto in each of the first direction and the second direction, but are disposed to be in contact with the second inner surface 421.

The respective second outer surfaces 422 of the plurality of second protrusions 420 may have different spaced distances according to a direction in which the second outer surfaces 422 are adjacent to each other. The second outer surface 422 of each of the plurality of second protrusions 420 may be spaced a second spaced distance d2 from the second outer surface 422 spaced apart therefrom in the first direction. The second outer surface 422 of each of the plurality of second protrusions 420 may be spaced the second spaced distance d2 from the second outer surface 422 spaced apart therefrom in the second direction. The second outer surface 422 of each of the plurality of second protrusions 420 may be spaced a third spaced distance d3 from the second outer surface 422 spaced apart therefrom in a direction parallel to one side of the second outer surface 422. The second outer surface 422 of each of the plurality of second protrusions 420 may be spaced the third spaced distance d3 from the second outer surface 422 spaced apart therefrom in a direction parallel to the other side of the second outer surface 422. As the second outer surfaces 422 of the plurality of second protrusions 420 are different in spaced distance according to the direction, in which the second outer surfaces 422 are adjacent to each other, and the third spaced distance d3 is smaller than the second spaced distance d2, a welding deviation be small.

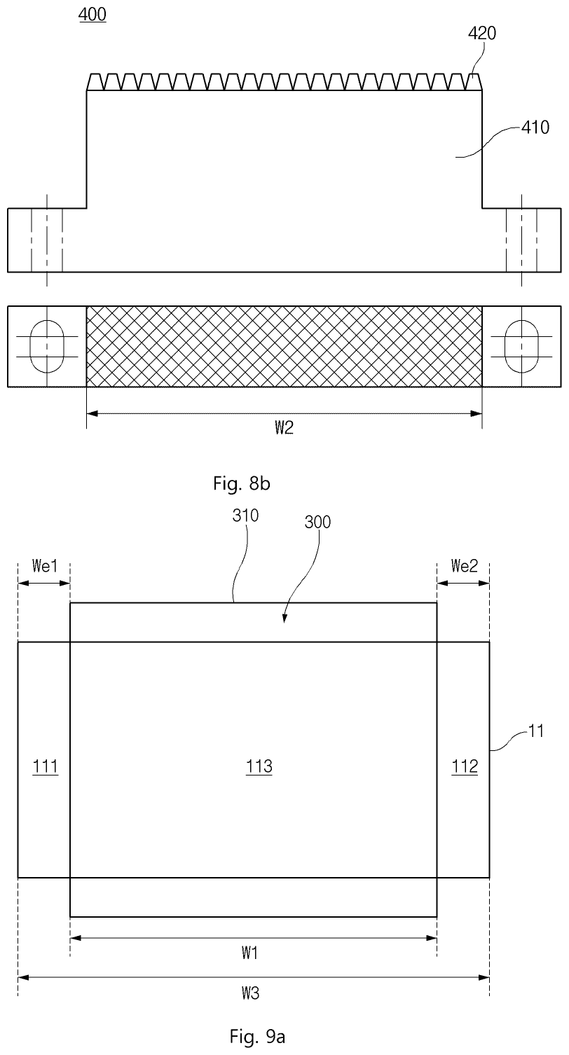

FIGS. 8a and 8b are views for explaining a width relationship between a horn and an anvil during a process of manufacturing a secondary battery according to an embodiment of the present invention.

Referring to FIGS. 8a and 8b, a horn 300 and an anvil 400 may be aligned to oppose each other during a process of manufacturing a secondary battery according to an embodiment of the present invention. A first welding surface 310 of the horn 300 and a second welding surface 410 of the anvil 400 may be disposed to face each other. First protrusions (e.g., the first protrusions 320 in FIGS. 3 and 4) may be provided on the first welding surface 310, and second protrusions 420 may be provided on the second welding surface 410.

The second welding surface 410 may have a size that is greater than or equal to a size of the first welding surface 310. For example, the second welding surface 410 may have a second width W2 that is greater than or equal to a first width W1 of the first welding surface 310. As the second welding surface 410 of the anvil 400 is provided to be greater than or equal to the first welding surface 310 of the horn 300, an area of an electrode tab (e.g., the electrode tab 11 in FIG. 2), which is in contact with (or pressed by) the first welding surface 310 of the horn 300, may be provided as a welded area. A non-welding area may be prevented from occurring in the area of the electrode tab, which is pressed by the horn 300.

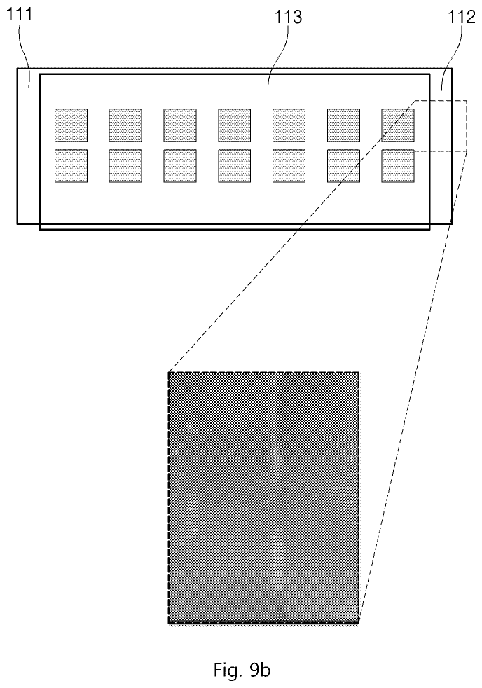

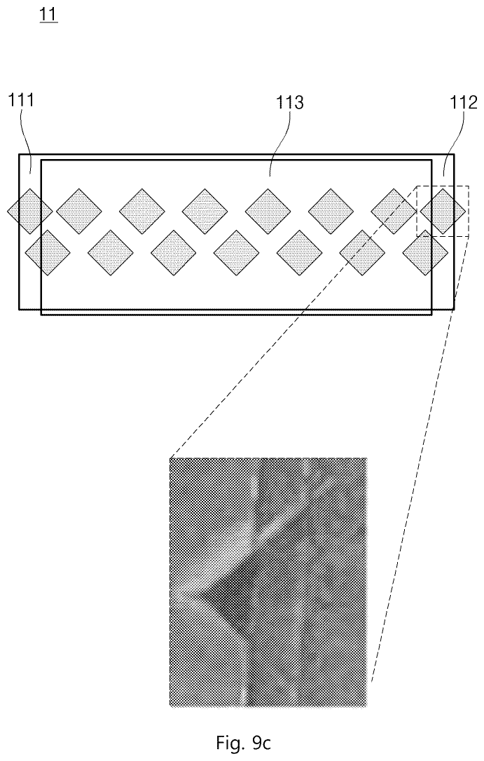

FIG. 9a is a view for explaining an arrangement relationship between a horn and an electrode tab during a process of manufacturing a secondary battery according to an embodiment of the present invention. FIG. 9b is a view illustrating an electrode tab after a manufacturing process according to an embodiment of the present invention. FIG. 9c is a view illustrating an electrode tab after a manufacturing process according to comparative example. An electrode tab 11 illustrated in FIGS. 9a to 9c may be an electrode tab extending from a stacked type or stack and folding type electrode assembly.

Referring to FIG. 9a, the electrode tab 11 may be aligned with a horn 300 during a process of manufacturing a secondary battery according to an embodiment of the present invention. The horn 300, of which a first welding surface 310 has a first width W1, and the electrode tab 11 having a third width W3 may be aligned for the welding process. The first width W1 may be smaller than the third width W3. For example, the first width W1 of the horn 300 may be provided to be smaller than the third width W3 of the electrode tab 11 by 2 mm to 2.5 mm.

Some areas of the electrode tab 11 aligned with the horn 300 may not overlap first protrusions (e.g., the first protrusions 320 in FIG. 4) of the horn 300, and remaining areas of the electrode tab 11 may not overlap the horn 300. A central area 113 of the electrode tab 11 may overlap the first protrusions of the horn 300, and peripheral areas 111 and 112 of the electrode tab 11 may not overlap the first protrusions of the horn 300. The peripheral areas 111 and 112 of the electrode tab 11 may extend from some portions of the central area 113 of the electrode tab 11, respectively, to face each other. For example, the peripheral areas of the electrode tab 11 may include a first peripheral area 111 and a second peripheral area 112. The first peripheral area 111 and the second peripheral area 112 may be disposed to be spaced apart from each other in a width direction of the electrode tab 11.

The first peripheral area 111 of the electrode tab 11 may be aligned to protrude from one side of the horn 300 by a first extension width We1. The second peripheral area 112 of the electrode tab 11 may be aligned to protrude from the other side of the horn 300 by a second extension width We2. The first extension width We1 and the second extension width We2 may have the same size or difference sizes. For example, the first extension width We1 and the second extension width We2 may have the same size of 1 mm to 1.25 mm.

The central area 113 of the electrode tab 11 may be provided as a welded area and each of the first peripheral area 111 and second peripheral area 112 of the electrode tab 11 may be provided as a non-welding area, after the welding process using the horn 300 aligned with the electrode tab 11. Even when there is meandering of foil forming the electrode tab 11, each of the peripheral areas 111 and 112 of the electrode tab 11 may be provided as a non-welding area because the width of the horn 300 is smaller than the width of the electrode tab 11. Accordingly, the peripheral areas 111 and 112 of the electrode tab 11 may be prevented from being pressed during the welding process and thus, the tensile strength of the peripheral areas 111 and 112 of the electrode tab 11 may be increased.

Specifically, in the electrode tab 11 according to an embodiment after the welding process using the horn 300 having a width smaller than that of the electrode tab 11, each of the first peripheral area 111 and the second peripheral area 112 may be provided as a non-welding area and the central area 113 may be provided as a welded area as illustrated in FIG. 9b. As the peripheral areas 111 and 112 of the electrode tab 11 are not pressed by the horn 300 during the welding process, the foil of each of the peripheral areas 111 and 112, which forms the electrode tab, may be prevented from being damaged.

On the other hand, in the electrode tab 11 according to Comparative Example after the welding process using the horn 300 having a width greater than that of the electrode tab 11, each of the first peripheral area 111, the second peripheral area 112, and the central area 113 may be provided as a welded area as illustrated in FIG. 9c. As the peripheral areas 111 and 112 of the electrode tab 11 are pressed by the horn 300 during the welding process, the foil forming each of the peripheral areas 111 and 112 may be damaged.

For example, it may be seen that an embodiment, in which the horn 300 is smaller than the electrode tab 11 by 2 mm, has higher tensile strength by about 8% than Comparative Example, in which the width of the horn is greater than the width of the electrode tab by 3 mm, as in Table 1.

TABLE 1

| | Embodiment | Comparative Example |
|---|---|---|
| Tensile strength | 9.02 | 8.38 |
| (kgf) | | |

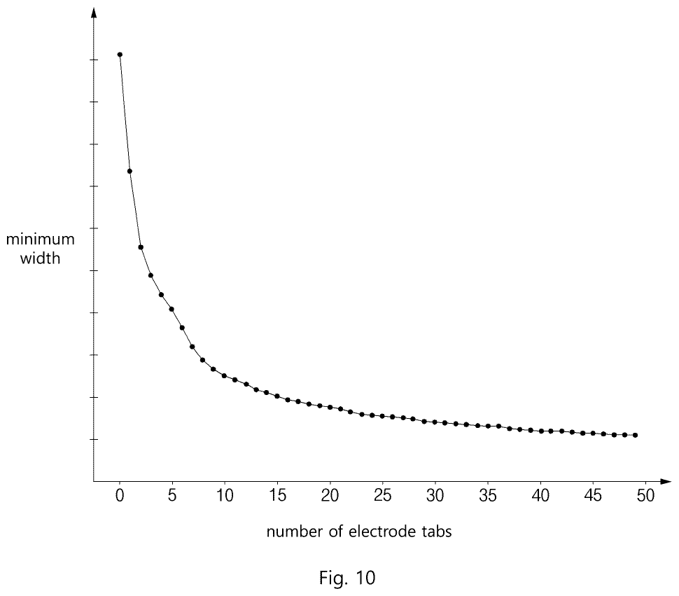

Accordingly, in an embodiment according to the present invention, as the tensile strength of the peripheral areas 111 and 112 of the electrode tab 11 relatively increases, a risk of disconnection of the electrode tab 11 may be reduced. FIG. 10 is a view for explaining a relationship between the number of stacked electrode tabs of a secondary battery and a first width of a first welded surface according to an embodiment of the present invention. Referring to FIG. 10, as the number of the stacked electrode tabs (e.g., the electrode tabs 11 in FIG. 9a) increases, a first width (e.g., the first width W1 in FIG. 9a) of a first welding surface (e.g., the first welding surface 310 in FIGS. 3 and 4) of the horn (e.g., the horn 300 in FIGS. 3 and 4) may be decreased. In addition, as a thickness of the electrode tab increases, a pitch of at least one of the first protrusion of the horn or the second protrusion (e.g., the second protrusion 420 in FIGS. 6 and 7) of the anvil (e.g., the anvil 400 in FIGS. 6 and 7) may be increased. The thickness of the electrode tab may be calculated by multiplying the number of the stacked electrode tabs and the thickness of one sheet of foil. The electrode tabs having a predetermined thickness may be welded to each other through the welding process using the horn and the anvil that include protrusions having different pitches. For example, the electrode tabs having a predetermined thickness may be welded to each other through the welding process using the horn including a first protrusion having a first pitch (e.g., the first pitch P1 in FIG. 3) and the anvil including a second protrusion having a second pitch (e.g., the second pitch P2 in FIG. 6) smaller than the first pitch. Each of a negative electrode tab and a positive electrode tab, which have the same thickness, may be welded through the welding process using the horn and the anvil that include protrusions having the same pitch or different pitches. For example, when the positive electrode tab and the negative electrode tab have the same thickness, the horn and the anvil, which are applied to the negative electrode tab, may have the same or greater pitches than the pitches of the horn and the anvil applied to the positive electrode tab, respectively.

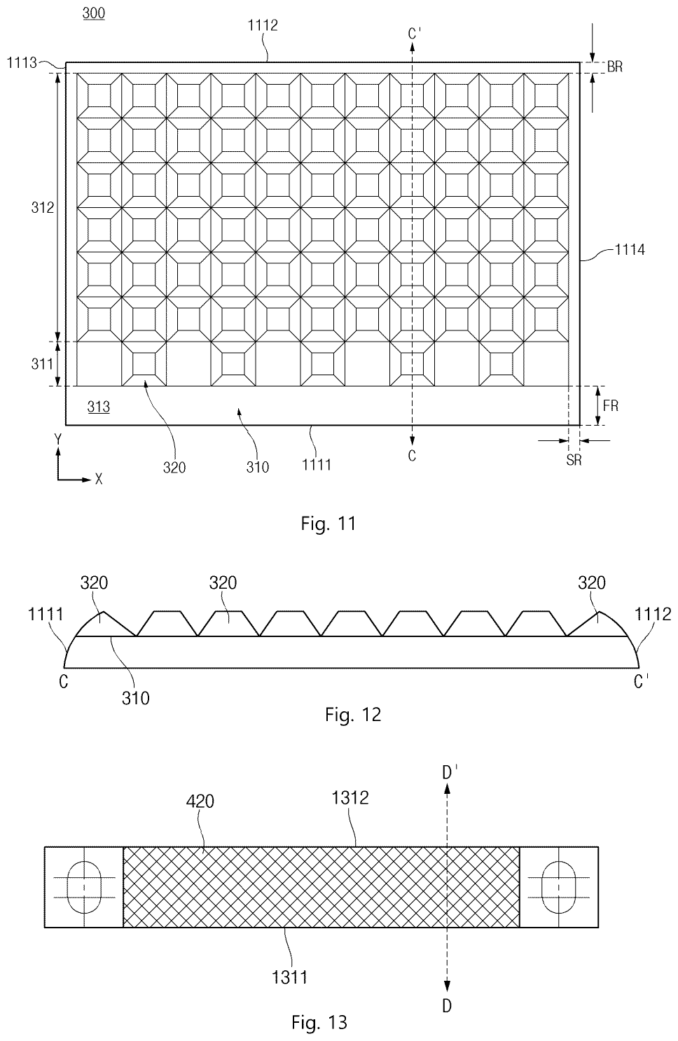

FIG. 11 is a plan view illustrating a horn having a side surface having a curved surface shape according to another embodiment of the present invention. FIG. 12 is a cross-sectional view taken along a line “C-C′” in FIG. 11.

Referring to FIGS. 11 and 12, a first welding surface 310 of the horn according to another embodiment of the present invention may include a first area 311, a second area 312, and a third area 313. The description of the first area 311 and the second area 312 of the first welding surface 310 described with reference to FIGS. 3 and 4 may apply to the first area 311 and the second area 312 of the first welding surface 310 illustrated in FIGS. 11 and 12 and thus, duplicate description will be omitted.

The third area 313 of the first welding surface 310 may be disposed to surround a portion of the first area 311 and a portion of the second area 312. The third area 313 of the first welding surface 310 may be in contact with each of a first side surface 1111, a second side surface 1112, a third side surface 1113, and a fourth side surface 1114 of a horn 300, to define an edge. The first side surface 1111 may extend in a first direction (e.g., an X direction), and be disposed to be close to a start point of an electrode tab (e.g., the electrode tab 11 in FIG. 2) during the welding process. The second side surface 1112 may be disposed to face the first side surface 1111, and disposed to be far from the start point of the electrode tab during the welding process. The third side surface 1113 may extend in a second direction, and be disposed between the first side surface 1111 and the second side surface 1112. The fourth side surface 1114 may be disposed to face the third side surface 1113.

The edge, which is defined so that the third area 313 is in contact with each of the first side surface 1111, the second side surface 1112, the third side surface 1113, and the fourth side surface 1114, may be provided to have a gentle curved surface. The edge having a curved surface shape, which is defined on the horn 300, may disperse pressure applied to the electrode tab and thus, damage to the electrode tab may be prevented.

In order to define the edge of the horn to have a curved surface shape, at least one of the first side surface 1111, the second side surface 1112, the third side surface 1113, or the fourth side surface 1114 may be provided to have a curved surface shape through a processing process (e.g., chamfering). The second side surface 1112, the third side surface 1113, the first side surface 1111, and the fourth side surface 1114 may be processed in sequence.

According to an embodiment, a side surface, which is disposed to be close to a start point of the electrode tab during the welding process among the first side surface 1111, the second side surface 1112, the third side surface 1113, and the fourth side surface 1114, may be provided to have a curvature radius greater than the other side surfaces. The curvature radius of the first side surface 1111 may be provided to be greater than a curvature radius of at least one of the second side surface 1112, the third side surface 1113, or the fourth side surface 1114. For example, the respective curvature radiuses of the second side surface 1112, the third side surface 1113, and the fourth side surface 1114 may be provided to be the same, and the curvature radius of the first side surface 1111 may be provided to be greater than the curvature radius of each of the second side surface 1112, the third side surface 1113, and the fourth side surface 1114.

According to an embodiment, each of the outermost first protrusions 320, which are adjacent to each of the first side surface 1111, the second side surface 1112, the third side surface 1113, and the fourth side surface 1114, may also have a side surface having a rounded shape during the processing process. In this case, each of the outermost first protrusions 320 adjacent to the first side surface 1111 may have a curvature radius that is greater than that of each of the outermost first protrusions 320 adjacent to each of the second side surface 1112, the third side surface 1113, and the fourth side surface 1114.

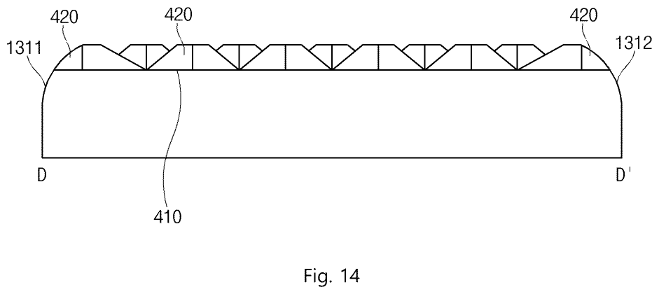

FIG. 13 is a plan view illustrating an anvil having a side surface having a curved surface shape according to another embodiment of the present invention. FIG. 14 is a cross-sectional view taken along a line “D-D′” in FIG. 13. The description of the anvil described with reference to FIGS. 6 and 7 may apply to the anvil illustrated in FIGS. 13 and 14 and thus, duplicate description will be omitted.

Referring to FIGS. 13 and 14, an anvil 400 according to an embodiment of the present invention may include one side surface 1311 and the other side surface 1312 that face each other. Each of the one side surface 1311 and the other side surface 1312 of the anvil 400 may be in contact with a second welding surface 410 to define an edge. The edge, which is defined so that the second welding surface 410 is in contact with each of the one side surface 1311 and the other side surface 1312, may be provided to have a gentle curved surface. The edge having a curved surface shape, which is defined on the anvil 400, may disperse pressure applied to an electrode tab (e.g., the electrode tab 11 in FIG. 1) and thus, damage to the electrode tab may be prevented.

In order to define the edge of the anvil 400 to have a curved surface shape, at least one of the one side surface 1311 or the other side surface 1312 may be provided to have a curved surface shape through a processing process (e.g., chamfering). The respective curvature radiuses of the one side surface 1311 and the other side surface 1312 may be the same as or different from each other. For example, the respective curvature radiuses of the one side surface 1311 and the other side surface 1312 may be the same as each other.

According to an embodiment, each of the outermost second protrusions 420, which are adjacent to each of the one side surface 1311 and the other side surface 1312, may also have a side surface having a rounded shape during the processing process. In this case, each of the outermost second protrusions 420 adjacent to the one side surface 1311 may have a curvature radius that is the same as that of each of the outermost second protrusions 420 adjacent to the other side surface 1312.

Although the present invention has been described with reference to the limited embodiments and drawings, the present invention is not limited thereto and may be variously implemented by those of ordinary skill in the art to which the present invention pertains, within the technical idea of the present invention and an equivalent of the appended claims.

[Description of the Symbols]

| | |
|---|---|
| 1: Secondary battery | 10: Electrode assembly |
| 11: Electrode tab | 200: Welding apparatus |
| 300: Horn | 320, 420: Protrusion |
| 400: Anvil | |

1. A welding apparatus comprising:
a horn having a first welding surface on which a plurality of first protrusions are provided; and
an anvil having a second welding surface on which a plurality of second protrusions are provided, wherein the anvil is oriented to face the horn with a plurality of electrode tabs, which are provided in a secondary battery, therebetween,
wherein each of the plurality of first protrusions has a planar cross-section having a shape different from a shape of a planar cross-section of each of the plurality of second protrusions, and
wherein each of the plurality of electrode tabs aligned between the horn and the anvil has a width greater than a width of the horn.

2. The welding apparatus of claim 1, wherein each of the plurality of electrode tabs comprises:
a start point and an end point, the start point being disposed further away from an electrode lead provided in the secondary battery than the
end point, the end point being disposed adjacent to the electrode lead,
wherein the first welding surface comprises:
a first area adjacent to the start point of the plurality of electrode tabs; and
a second area disposed away from the start point of the electrode tab,
wherein each of the plurality of first protrusions is disposed to be spaced apart from each of the plurality of first protrusions adjacent thereto on the first area, and
wherein each of the plurality of first protrusions is disposed without spacing from the first protrusion adjacent thereto on the second area.

3. The welding apparatus of claim 2, wherein, in the first area, a spaced distance between the plurality of first protrusions is a same dimension as a pitched dimension of each of the plurality of first protrusions.

4. The welding apparatus of claim 1, wherein at least one of the first protrusions or the second protrusions has a pitch in a range of 1.2 mm to 1.5 mm.

5. The welding apparatus of claim 1, wherein the width of the horn is smaller than the width of the plurality of electrode tabs by a range of 2 mm to 2.5 mm.

6. The welding apparatus of claim 1, wherein the anvil has a width that is greater than or equal to the width of the horn.

7. The welding apparatus of claim 1, wherein each of the first protrusions and each of the second protrusions has a shape of a frustum of a quadrangular pyramid,
the first protrusion comprises a first outer surface facing the anvil, wherein the first outer surface has a rectangle shape having a first horizontal length extending in a first direction and a second horizontal length extending in a second direction, and
the second protrusion comprises a second outer surface facing the horn, wherein the second outer surface is parallel to the first outer surface and has a rhombus shape in which a first diagonal length is transverse to the first direction and a second diagonal length is transverse to the second direction, the first and second diagonals being perpendicular to each other.

8. The welding apparatus of claim 2, wherein the horn comprises a first side surface, a second side surface, a third side surface, and a fourth side surface, each of which is in contact with the first welding surface to define an edge,
wherein one side surface of the first side surface, the second side surface, the third side surface, and the fourth side surface has a curvature radius greater than each of remaining side surfaces of the first side surface, the second side surface, the third side surface, and the fourth side surface.

9. The welding apparatus of claim 8, wherein the first side surface is disposed to be adjacent to the start point of the plurality of electrode tabs, and
wherein the first side surface has the curvature radius greater than at least one of the second side surface, the third side surface, or the fourth side surface.

10. A welding method comprising:
aligning a horn, which has a first welding surface on which a plurality of first protrusions are provided, and an anvil, which has a second welding surface on which a plurality of second protrusions are provided; to face each other; and
pressing a plurality of electrode tabs provided in a secondary battery using the horn,
wherein each of the first protrusions has a planar cross-section having a shape different from a shape of a planar cross-section of each of the second protrusions, and
each of the electrode tabs aligned between the horn and the anvil has a width greater than a width of the horn.
